(19) United States
(12) Patent Application Publication
(10) Pub. No.: US 2009/0068617 A1
(43) Pub. Date: Mar. 12, 2009

(54) Method Of Designing Dental Devices Using Four-Dimensional Data

(76) Inventor: Mark D. Lauren, Amherst, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/267,906

(22) Filed: Nov. 10, 2008

Related U.S. Application Data
(63) Continuation-in-part of application No. 11/367,632, filed on Mar. 3, 2006.
(60) Provisional application No. 61/010,868, filed on Jan. 14, 2008.
(60) Provisional application No. 61/070,686, filed on Mar. 26, 2008.

(51) Int. Cl. A61C 11/00

(52) U.S. Cl. 433/213

(57) ABSTRACT

The present invention provides methods for acquiring and utilizing time-based 3d jaw motion images (4d datasets) to enhance the computer-aided design (CAD) of dental devices, which may include dental restorations, oral prostheses, and oral appliances. These 4d datasets may be used directly to provide a jaw motion model suitable for enhanced CAD or, they may be used to derive mathematical expressions that are then used to drive a motion simulation. The methods of the invention are based on acquiring time-based 3d images (a 4d sequence) of the upper and lower teeth, with each 3d frame in the time sequence capturing some upper and lower arch anatomy (the oral anatomy). Each image in the 4d sequence may therefore contain an accurate record of the relationship between the upper and lower arch in three dimensions.

### CROSS-REFERENCE TO RELATED APPLICATION

This application claims the benefit of priority to U.S. provisional patent application Ser. No. 61/010,868, filed on Jan. 14, 2008, now pending, and U.S. provisional patent application Ser. No. 61/070,686, filed on Mar. 26, 2008, now pending. Further, this patent is a continuation-in-part of U.S. patent application Ser. No. 11/367,632, filed Mar. 3, 2006, now pending. The disclosures of the above priority documents are incorporated herein by reference.

### FIELD OF THE INVENTION

The present invention relates to methods for utilizing 4-dimensional (4d) data, represented by time-based 3-dimensional (3d) jaw motion images, and more particularly, to the use of these data to enhance the computer-based design of dental prosthetics.

### BACKGROUND OF THE INVENTION

Computer aided design (CAD) and computer aided manufacturing (CAM) have been applied to dental prosthetics since 1987, with the market launch of the CEREC dental CAD/CAM system from Sirona Dental Systems, Inc., (Bensheim, Germany) for the chairside production of ceramic crowns.

Any tooth that occludes or contacts a new dental device, for example, a new tooth, being designed is termed an antagonist tooth. The crown of the new tooth, designed using CAD software, should properly contact the surface of the antagonist when occluded, and not interfere with any teeth when the jaw is moved. The CAD/CAM of dental prosthetics is currently based on the following scheme (illustrated for replacing a single tooth):
1. Making a taper-style preparation to the tooth to be replaced;
2. Obtaining a 3d model of the prepared tooth and its neighbors by either scanning a cast made from an impression or direct intra-oral scanning;
3. Taking a closed-mouth bite registration of the occlusal surfaces of the antagonist teeth against the prepared tooth and its neighbors;
4. Scanning this bite registration to capture the occlusal surface of the antagonist tooth;
5. Virtually locating a new tooth over the preparation, and designing the occlusal surface of the new crown to fit against the fixed antagonist surface; and
6. Importing the designed crown file into CAM software and machining the restoration.

Faster and more accurate methods for digitizing the dentition, computer speeds and graphics, 3d design tools, restorative materials, and high-speed machining have each advanced the art. However, current CAD of dental crowns, bridges, and dental implants is still performed at a fixed or static position of the upper and lower arches, usually centric occlusion (CO) or maximum intercuspation.

With a fixed antagonist boundary surface, intersections between the new tooth and the static boundary surface are readily visualized, and provide the primary design parameters in modern CAD software for dental restorations. The intersections indicate locations where the CAD designer needs to reshape the new tooth. Current dental CAD software employs a variety of jogging, twisting, and bumping motions to reposition and fit the new tooth against the antagonist boundary surface. These motions are not based on any dental, anatomic, orthognathic, or articulation criteria, and do not attempt to simulate any real jaw movement.

Since there is no way to account for the tooth interferences that will occur when the jaw is moved, this process leads to the need for adjustments by the dentist when fitting current prosthetics to a patient. Such chairside adjustments, which involve grinding away areas of the new crown that interfere, are known to significantly affect the long-term performance of dental restorations. This requirement to make chairside adjustments is a distinct shortcoming of current CAD software.

The term ‘antagonist system’ is used when referring to all of the teeth that must be considered when designing a specific restoration. The antagonist system may include the preparation, the new tooth, the teeth mesial and distal to the new tooth, and the antagonist teeth in the arch opposite the new tooth.

Attempts to provide orthognathically-enhanced CAD of dental crowns by: a) applying average articulation parameters through the use of virtual articulators; and b) using functionally-generated paths (FGP) have been reported. Also, while 3d electronic jaw tracking devices have been available for several years, no work to date has reported the use of patient-specific motion data from these devices to provide enhanced dental restoration design. As a group, jaw tracking devices remain cumbersome and provide insufficient accuracy for this application.

The effects of incorporating average theoretical articulation values in dental CAD to simulate jaw motion to assist with crown design were demonstrated by Olthoff and van der Zel. While significant 3d occlusal corrections were shown, no clinical data were reported. This group also stated that “[i]deal individual crown morphology is difficult to design because it requires modeling the relation between a crown and its antagonist during oral (para)function.” The average theoretical articulation techniques presented by Olthoff and van der Zel provide potential improvements in crown design but still do not reflect the actual movement of the patient's mouth.

Functionally generated bite surfaces, created in the mouth by moving antagonist teeth against a soft wax, have been scanned and used to produce 3d dynamic surfaces to assist with crown design. This surface, which lies above the preparation for a new tooth, forms an interference boundary for the new tooth. Methods using functionally generated bite surfaces can be effective in reducing interferences of new restorations, but they require careful handling to achieve the necessary accuracy.

Methods for 3d data capture and model manipulation are also known in current art. Time is often considered the fourth dimension in physics. Time-based changes in 3d systems constitute a 4-dimensional (4d) system. The acquisition of time-based 3d data is also referred to as 4d scanning. Four-dimensional methods have been used to study jaw dynamics by tracking the 3d position of markers located on frames attached to the maxilla and mandible using optical tracking systems. These methods all remain somewhat cumbersome and technically complex. For example, the Axiograph® from Great Lakes Orthodontics, utilizes frames mounted to a persons head to track jaw motion. Reported accuracy is in the 300-400 micron range, which is not adequate for prosthesis design.

Current art does not provide any convenient means for capturing 3d patient-specific jaw motion with sufficient accuracy to be useful for enhancing crown design. This limitation has confined dental prosthetics CAD to a static system. Also, while modeling dental articulators in CAD can provide a general benefit, it cannot duplicate an individual's jaw movements which are required for designing interference-free dental restorations.

Without considering patient-specific jaw motion, many of the possible tooth interferences cannot be considered during crown design, and crown anatomy is not optimized. A dynamic approach is required to better simulate the in-vivo system. The current invention provides convenient methods to capture and utilize accurate 3d jaw motion data for improved CAD design of dental prosthetics. The methods of this invention apply to the design of dental restorations such as crowns, bridges, copings, implants systems and components, dentures, and the like. Tooth interferences can be predicted and considered during design, which leads to a better fitting prosthesis and less adjustment by the dentist. The invention also describes commercial systems for carrying out the described methods.

### BRIEF SUMMARY OF THE INVENTION

The present invention provides methods for acquiring and utilizing time-based 3d jaw motion images (4d dataset) to enhance the CAD of dental restorations. These 4d datasets may be used directly to provide a jaw motion model suitable for enhanced CAD or, they may be used to derive mathematical expressions that are then used to drive a motion simulation. The methods of the invention are based on acquiring time-based 3d images (a 4d sequence) of the upper and lower teeth, with each 3d frame in the time sequence capturing some upper and lower arch anatomy (the oral anatomy). Each image in the 4d sequence may therefore contain an accurate record of the relationship between the upper and lower arch in three dimensions. While the scans may not capture the complete dentition, sufficient 3d data should be present to allow other 3d models of the dentition to be registered to the scans to provide a more complete representation of the arches. The acquisition of 4d datasets may be performed intra-orally (the acquisition device located within a patient's mouth) or extra-orally (the acquisition device located outside of the patient's mouth).

The dental device may also be designed using mathematical models wherein the mouth is first 4d scanned and the antagonist/preparation anatomy is registered to the scans (FIG. 4). Mathematical expressions are then derived to describe the 3d change in jaw position from a reference position to its position in frame n. One such expression is a 6D of which is a six degree of freedom expression. A set of 6D of expressions is derived corresponding to a particular 4d scanning sequence. After locating a new tooth over the preparation using CAD, the 6D of expressions can be used to animate antagonist free body motion with respect to a new tooth to reflect the patient-specific motion. This also then allows the application of interpolation and smoothing functions to the motion.

It is possible to compute the 6D of expressions directly from the 4d scans if the individual scans contain sufficient orthogonal 3d data. This is one advantage of extraoral scanning, since intraoral scanning generally produces limited data in orthogonal directions. FIG. 5 diagrams a 4d process wherein a 6D of model is calculated directly from the 4d scans. After defining a reference image from a sequence, the upper anatomy of the individual images are registered to the upper anatomy of the reference scan. The 6D of expressions are relative to a reference frame. Therefore, it is necessary to only register the antagonist system to the reference frame. The 6D of expressions can then be used to animate the system based on the reference frame.

The 3d jaw motion may also be modeled by defining the 3d line path taken by a point on the surface of either the upper or lower arch or new tooth. After defining a point to be followed, a mathematical function can be developed to describe the 3d line path taken by the point during 4d scanning.

Clinically, time-based jaw position data may be captured using either intra- or extra-oral imaging systems. A variety of jaw motions can be digitized, including: open/close, protrusion and lateral movements, functional chew cycles, and random motions. Interferences can be visualized using transparent intersecting surfaces, and quantitative color or other visual means known in the art can be used to display quantitative information.

Enhanced CAD involves reshaping the new tooth using known software tools to both eliminate tooth interferences due to jaw motion as well as to optimize the occlusal geometry. Interferences can be visualized using transparent intersecting surfaces, and quantitative color or other visual means known in the art can be used to display quantitative information. By considering the mandible's arc-of-motion, the direction of entry of cusp tips into and across the fossa can be considered. This provides better design control of cusp height and slope, as well as the width of tooth fossa and the direction of the intercuspal anatomy. The result is a more physiologically-designed crown that requires little or no chairside adjustment which leads to a longer-lasting restoration.

The present invention may also be embodied as a dental device designed using a 4d process similar to that described infra.

The methods of this invention may also be applied to veterinary prosthetics.

### DESCRIPTION OF THE DRAWINGS

For a fuller understanding of the nature and objects of the invention, reference should be made to the following detailed description taken in conjunction with the accompanying drawings, in which:

FIG. 1 is a flow chart of a method according to the invention;

FIG. 2 is a flow chart of a method according to the invention;

FIG. 3 shows an example frame taken from a 4d sequence according to the invention;

FIG. 4 is a flow chart of a method according to another embodiment of the invention;

FIG. 5 is a flow chart of the method of FIG. 2 wherein the 4d scans are used to directly calculate the 6D of expressions;

FIG. 6 shows an antagonist system from a buccal aspect;

FIG. 7 is a perspective view of the 4d extra-oral camera system;

FIG. 8 is an example of a reference frame or scan (F1);

FIG. 9 shows more complete upper anatomy registered to the reference frame of FIG. 8;

FIG. 10 shows more complete lower anatomy registered to the reference frame of FIG. 8;

FIG. 11 shows a second frame in a sequence;

FIG. 12 shows the upper data set registered to FIG. 11;

FIG. 13 shows the result of registering the lower anatomy of the antagonist system, represented in this example by the full lower arch;

FIG. 14 diagrams an example commercial process for the 4d method of this patent;

FIG. 15 diagrams an example commercial 4d process for dental offices that have in-house 3d scanners; and

FIG. 16 diagrams an example commercial 4d process for dental offices that use intra-oral scanning.

### DETAILED DESCRIPTION OF THE INVENTION

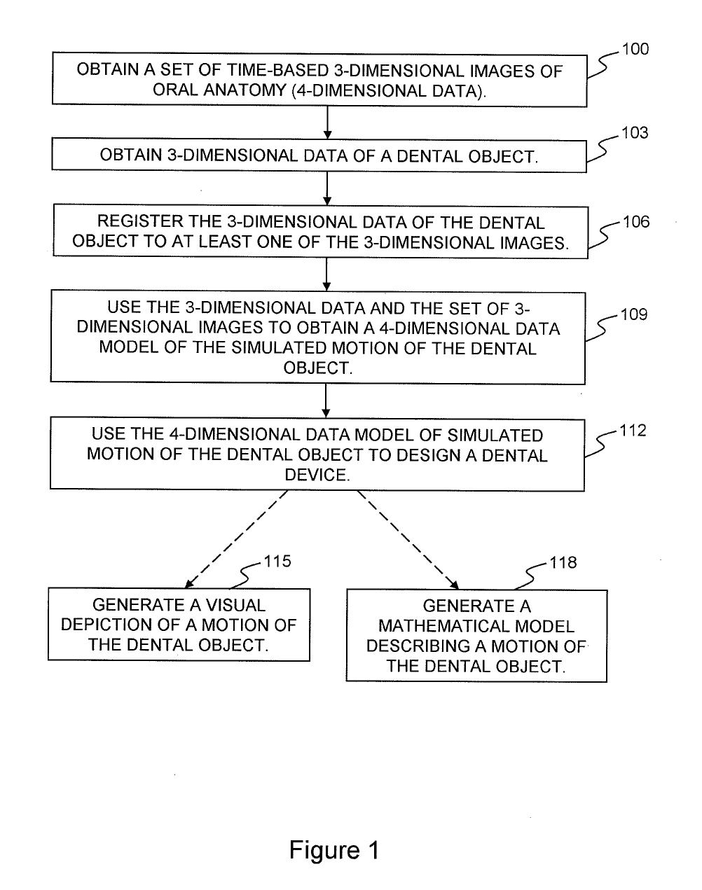

FIG. 1 depicts a method according to the present invention for designing a dental device wherein a set of time-based 3d images of a person's oral anatomy may be obtained in step 100. 3d data of a dental object may also be obtained in step 103. The 3d data of the dental object may be registered in step 106 to at least one of the images within the set of time-based 3d images. This registered data set (comprising the 3d data of the dental object registered to at least one image of the set of time-based 3d images) is used in step 109 to determine a 4d data model of the simulated motion of the dental object. And this 4d data model of the simulated motion of the dental object is used in step 112 to design a dental device.

To design the dental device, a visual depiction of the motion of the dental object may be generated in step 115, for example, by displaying the visual depiction to a computer screen. A mathematical model describing the motion of the dental object may be generated in step 118 to aid in the design of the dental object. Such a mathematical model may be used in automated techniques for determining design parameters.

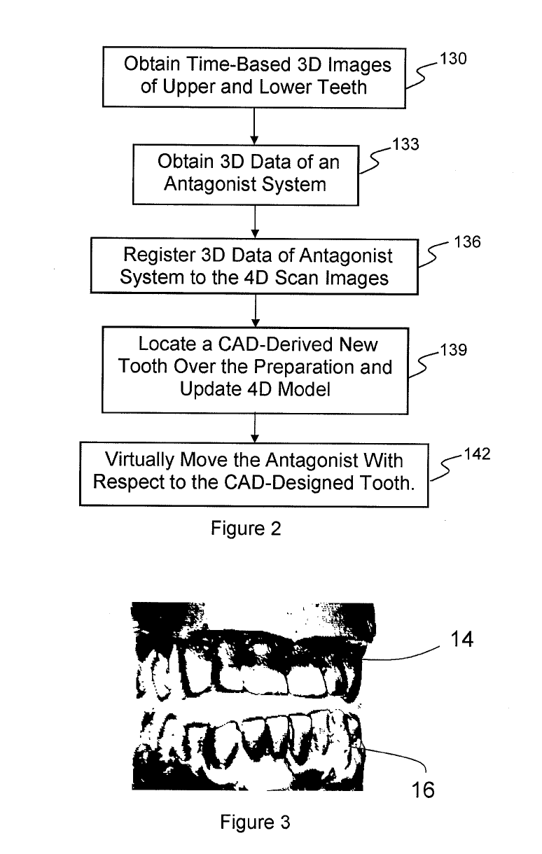

FIG. 2 depicts a method according to the present invention for designing a custom dental device. Time-based 3d image of a person's upper and lower teeth may be obtained in step 130. 3d data of an antagonist system may be obtained in step 133. In step 136, the 3d data of the antagonist system may be registered to the 4d scan images previously disclosed. A CAD-derived new tooth may be located (virtually) over the preparation in step 139 wherein the 4d model may be updated. The antagonist may be virtually moved with respect to the CAD-designed tooth in step 142 to design a custom dental device.

FIG. 3, according to the present invention, depicts an example frame of a person's oral anatomy referring to the person's upper teeth 14 and lower teeth 16 taken from a 4d sequence.

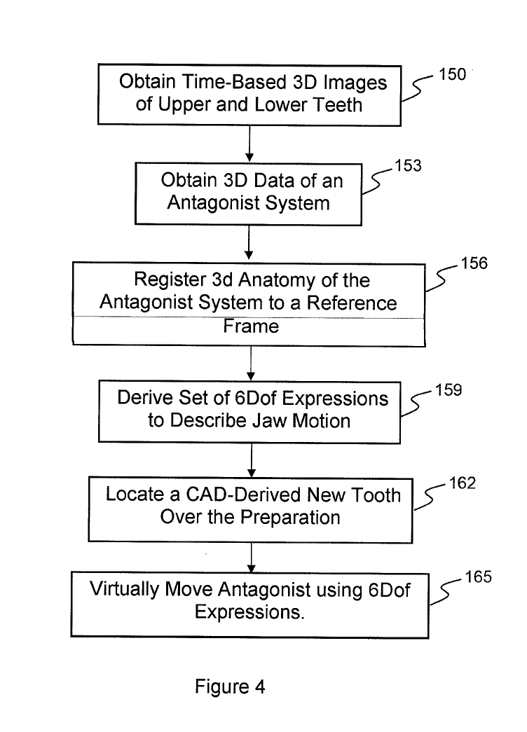

FIG. 4 depicts a method according to another embodiment of the present invention for designing a custom dental device. Time-based 3d images of a person's upper and lower teeth may be obtained in step 150. 3d data of an antagonist system is obtained in step 153. The 3d anatomy of the antagonist system may be registered to a reference frame in step 156. To describe jaw motion in step 159 a set of 6D of Expressions may be derived. In step 162 a CAD-derived new tooth over the preparation may be located. The antagonist may be virtually moved using 6D of expressions in step 165 to design a custom dental device.

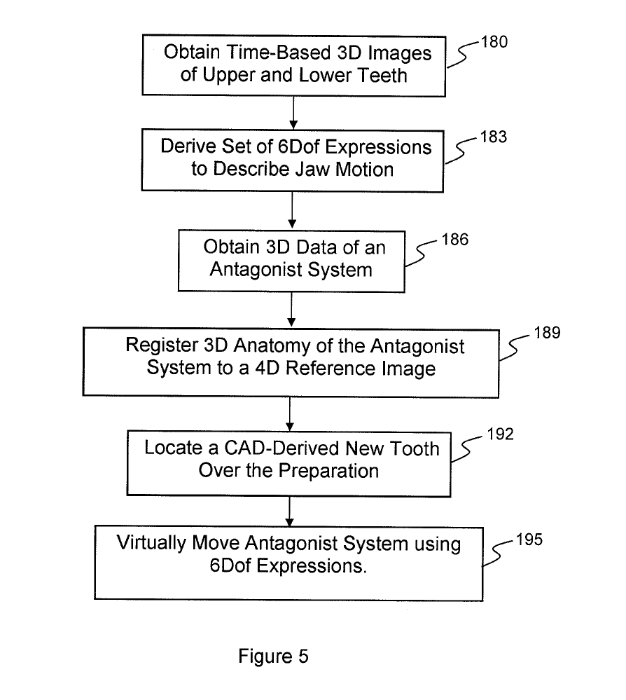

FIG. 5 depicts a method with respect to FIG. 2 according the present invention wherein the 6D of expressions may be directly calculated from the 4d scans. Time-based images of a person's upper and lower teeth may be obtained as in the first step 180. Jaw motion may be described in step 183 by deriving a set of 6D of expressions. In step 186 3d data of an antagonist system may be obtained. The 3d anatomy of the antagonist system may be registered in step 189 to a 4D reference image. A CAD-derived new tooth may be (virtually) located over the preparation in step 192. Using 6D of expressions the antagonist system may be virtually moved to design a custom dental device in step 195.

### 4D Scan

FIG. 2 depicts a method according to the present invention for designing a custom dental device. The first step comprises obtaining 4-dimensional data of an oral anatomy of a patient during jaw motion. A patient's mouth is 3d scanned at least two times, and preferably several times, during specific jaw motions to obtain a 4d sequence. FIG. 3 shows an example of a single frame in such a 4d sequence showing typical oral anatomy including an upper arch 14 and a lower arch 16. Various jaw motions may be digitized including, but not limited to: open/close, protrusion and lateral movements, functional chew cycles, clenching, and random movements. Other potentially useful jaw motions will be apparent to those skilled in the art.

The 4d data may be obtained through intra-oral or extra-oral scanning. For intra-oral scans, each scan may capture at least a portion of the preparation anatomy and at least a portion of the antagonist anatomy.

A digitizer may be used to capture the instantaneous 3d relative position of the mandible with respect to the skull by imaging a portion of the facial or buccal aspects of the upper and lower teeth 14, 16 and mucosa. The digitizer may be an optical imaging device, capable of acquiring at least 1 frame per second in 3d. Each image in the time-based series contains an accurate digital record of the relationship between the upper and lower arches in three dimensions.

The 4d data may be obtained through intra-oral or extra-oral scanning. For intra-oral scans, each scan may capture at least a portion of the preparation anatomy and at least a portion of the antagonist anatomy. Current intra-oral 3d imaging devices, such as, for example, the Brontes (3M ESPE Dental Products St. Paul, Minn.) and SureSmile systems (OraMetrix, Inc. Richardson, Tex.), may acquire time-based 3d optical images. Because these systems are used to digitize the dentition, the acquired 3d data is registered together to form a 3d mosaic representing the surface of the teeth. Motion, or 4-dimensional data manipulation, is not performed. The technology used for current intra-oral scanners can, however, be adapted for the purposes of this invention.

Extra-oral scanning of the facial/buccal aspect of the oral anatomy may capture more data in orthogonal directions than the intraoral method. A suitable imaging device to perform a method according to the present invention may consist of a hand-held structured light or laser scanner that may primarily capture the facial and buccal aspect of a patient's oral anatomy. The oral anatomy may include portions of the upper and lower teeth 14, 16 and soft tissues. The unit is preferably capable of acquiring 3d images at a rate of 50 images per second (frame rates of approximately 50 Hz).

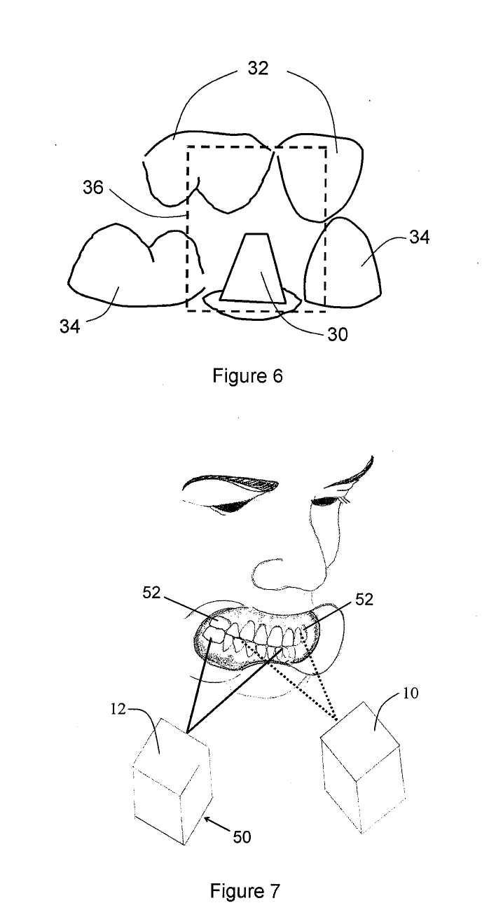

FIG. 6 shows an antagonist system from a buccal aspect. A new tooth preparation 30 and the mesial-distal adjacent teeth 34 are shown. The occluding antagonist teeth 32 are shown. The dotted rectangle 36 shows a typical view taken from a buccal aspect that may be used to build a 4d model using intraoral 4d scanning. The region includes some of the antagonist teeth 32 as well as the preparation 30 and adjacent teeth 34.

FIG. 7 shows an example of the positioning of an imaging device 50. The imaging device 50 can be positioned using light guides that may be projected from the imaging device 50 onto a patient's face. These guides ensure that the imaging device 50 is correctly positioned at the proper distance for the depth of field as well as the desired horizontal and vertical fields of view. The imaging device 50 may be located at a distance from the patient's mouth to allow the dentition to be imaged from, for example, the bicuspid 52 on the left side of the figure to the bicuspid 52 on the right side of the figure.

An imaging device 50 may comprise one or more cameras. The imaging device 50 may be positioned at a location 10 directly in front of the mouth 10, or at lateral locations, for example at location 12, to capture more distal anatomy. This may provide sufficient anterior-posterior distance to be imaged for accurate registration to other digital models. Vertically, the full open jaw position represents the maximum distance required to be imaged. The imaging device 50 may typically capture a portion of the upper and lower arches. Any imaging device 50 capable of acquiring equivalent data is suitable for the execution of the inventive method.

Structured light imaging systems may be suitable, as well as infra-red and ultrasonic-based methods of 3d image capture. The short acquisition time of these systems may reduce imaging distortion due to the relative motion between the camera and the patient's mouth, as well as relative motion between the upper and lower arches.

In a non-limiting example, a suitable extra-oral digitizer may comprise the following specifications:
Working distance: 1-6 inches;
Depth of field in Z: 1-4 inches;
XY field of view: 2×3 inches;
XY imaging resolution: approximately 20 microns;
Z resolution: approximately 50 microns; and
Capture rate: up to approximately 50 Hz.

The example extra-oral digitizer:
may be color or monochrome;
hand-held, light-weight, and/or wireless;
may be powered by rechargeable batteries;
may transmit data to a local computer for additional processing and/or transmission to an alternate site;
may use specific file locations for specific jaw movements to allow identification of camera data;
may use wireless data transmission;
may use alignment beams to assist positioning the camera to the mouth; and
may use a holding cradle which may serve as a data transfer unit, to facilitate downloading data from the camera.

In an alternate arrangement, used mainly for posterior restorations, scanning may take place at an angle to the front of the mouth to capture additional posterior anatomy. This may allow better registration of the 4d scan images to the region of interest. This scanning aspect may capture most of the anterior teeth as well as portions of the buccal molar anatomy. This arrangement may capture data over a greater x, y, and z range than a frontal scan. This is advantageous for the accurate registration of complete models because it may provide more data in three orthogonal directions.

The teeth within the camera's field of view may be coated with a material such as titanium dioxide to provide a clean surface reflection for the imaging device. The coating material may also assist with differentiating the upper and the lower arch. Colored, white, or other reflective materials or targets can be used to both assist with imaging as well as differentiating upper and lower arch anatomy. Commonly used intra-oral whitening sprays using titanium dioxide are suitable. Standard cheek retractors are used to keep the cheeks away from the teeth while the visualization material is applied to the teeth and the teeth are scanned.

Targets may be placed on the teeth to assist with identification and differentiation of the upper and lower arches. This may facilitate automatic computer software identification and differentiation of the upper and lower arches to assist with registration. The markers may be different colored dots or geometric patterns to facilitate automatic software identification using image analysis methods known in the art. After markers are identified in software, contiguous surface regions useful for registration may be identified using software by expanding the target area using geometric criteria for inclusion or exclusion. For example, regions of curvature not possible for tooth or gingival anatomy that might correspond to lip or other soft tissue areas can be excluded.

Extra-oral scanning may start with the incisal edges slightly apart. This may be aided by the use of a small occluder, placed between the incisal edges, which is removed when scanning. The occluder can, for example, be a small round rod placed at the incisal edges which may allow the patient to relax and swallow prior to scanning. In this case, one of the first scan frames may provide a reference position for building the 4d model.

Standard jaw motions for scanning may include protrusion, left and right-side lateral movements, and open/close. Lateral movement may be performed starting with the jaw in centric occlusion and proceeding to the left and right-side direction while maintaining occlusal contact of the teeth. This movement may be useful for reducing interferences of posterior teeth.

A patient-specific 4d closing arc may be computed for a patient by capturing jaw movement data during the initial opening and closing action of the jaw.

The clench position may also be captured with scans. A patient would be scanned for a short period of time in the clench position to obtain a typical or average clench position. The clench position may be particularly important to the design of dental implants because it represents the closest interdigitation of the two arches with the periodontal ligaments compressed. It is important that any new implant restoration and its antagonist surface not be in contact in the clench position. It is not desirable for a dental implant crown to contact its antagonist tooth in the clench position because the occlusal forces would be directly transmitted through the implant structure directly to the bone, since the implant does not have a periodontal ligament.

A chew-cycle motion is a functionally critical jaw motion, which cycle may be captured by the 4d scanner. This motion may provide a locus of positions assumed by the antagonist surfaces during normal chewing action. The 4d functional chew-in records the sphere of movement of a tooth or cusp through the complete natural chew cycle. A 4d model of a functionally-generated path may be created and used to render a dynamic antagonist surface against which the new device (for example, a crown) should not interfere. This locus of positions assumed by antagonist teeth during chew cycling may create a virtual chew-in surface with which a CAD-designed tooth cannot interfere. During the design process, the new tooth is adjusted to fit a patient's actual chew cycle. Random motion may also be captured and used.

The objective of scanning is to capture motion data useful for designing prosthetics. A number of different jaw motions can be imaged and used to enhance the CAD of dental devices. Each specific movement or random motion can be used individually to animate the antagonist tooth with respect to the new device. While individual border movements may be captured and utilized to aid prosthesis design, it may be more advantageous to capture motions that provide a sphere of movement.

### 3D Object Scan

Three-dimensional data may be obtained for a dental object through either intraoral scanning or digitizing a cast of the object. The object generally represents the oral anatomy system desired to be animated by the 4d data. The object may be (a) tooth preparation(s), an antagonist tooth, or an antagonist system (which may include any or all of the others or the entire upper arch, lower arch, or both). The data may comprise surface data of the dental object. 3d digitization of cast models is commonly known in the art, for example, as described in U.S. patent application publication no. 2006/0003292.

### Registration

Registration is the process of matching two 3d surfaces by analyzing the overlapping regions. Generally, registration is performed to combine two 3d surfaces into a single larger object. Overlapping 3d surface anatomy between the object of interest and the 4d scans may be used to register the object surface to at least one of the 4d scan images. Registering the 3d data (having fixed structural detail) to the 4d data (having jaw motion data) enables the object system to be moved or virtually simulated according to the jaw motion recorded in the 4d scans. Accurate registration may be achieved by causing the overlapping region to span a large range in three orthogonal directions.

Two methods are described for developing useful 4d models of object motion: (1) a frame-by-frame registration of the 3d object surface with the individual 4d scans; and (2) a mathematically-based method for describing the incremental change in position of the lower arch as captured by the 4d scanning. Both models may utilize a reference frame as the basis for analyzing incremental motion. Both models are amenable to: (1) determining dynamic surfaces and closure arcs; and (2) visualizing and quantifying interferences within an antagonist tooth system.

### Example Using Frame-by-Frame Registration

This method is the basis for animating an antagonist object system without computing mathematical expressions, as outlined in FIG. 2. The following sequence is provided as a non-limiting example only. In this example, the full upper and lower arch of teeth is used as the object system. An equivalent result may be obtained using a different progression along the same technical aspects.

A single 3d image in a time-based sequence may be defined as a reference frame. The reference frame may be used to define the fixed location of the upper arch. Any frame in a sequence may serve as a reference frame. The reference frame may also be an image formed by registering and merging a set of images. For intraoral scanning, a convenient reference position or frame may be the centric occlusion position. For extraoral scanning, a convenient reference position may be with the incisal edges slightly separated.

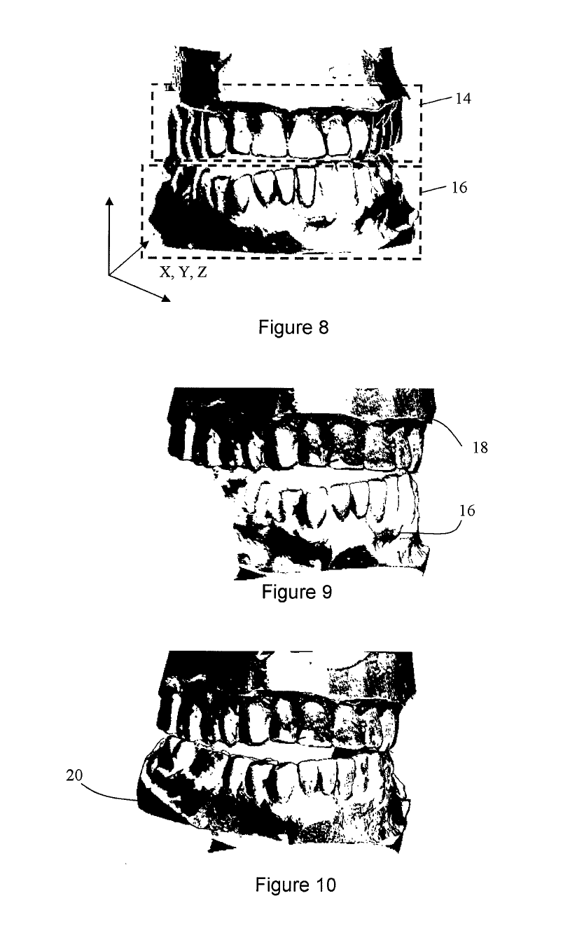

A reference frame, designated F1 for frame No. 1, is shown as FIG. 8. The world coordinate system may be fixed with respect to the imaging device. All objects imaged by the camera may be defined in this system. This frame may define the fixed position of the upper arch 14 for building the 4d model. The 3d data of the complete upper arch anatomy of an object system may then be registered to the reference frame to provide the upper object system registration 18 and saved as a new 3d file shown as FIG. 9. The 3d data of the complete lower arch anatomy of the object system may then be registered to the lower data set in the reference frame to provide the lower object system registration 20 to the reference frame, shown as FIG. 10.

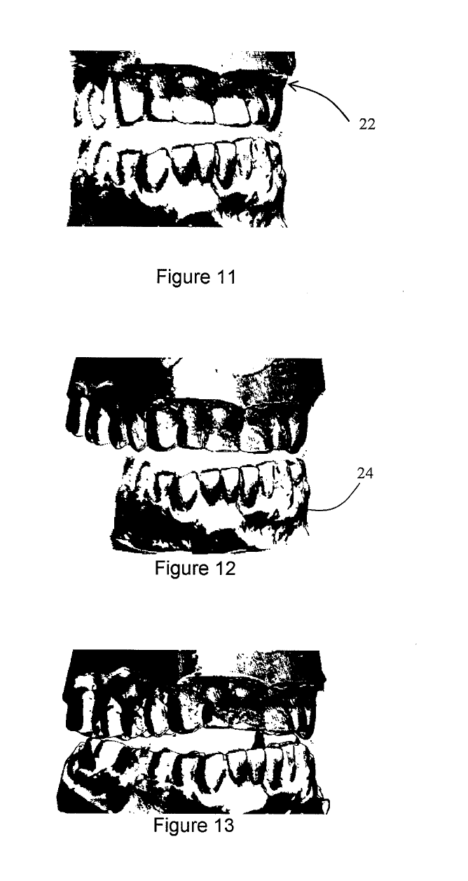

FIG. 11 shows a second frame in the 4d sequence, designated F2, with the jaw slightly open relative to the reference frame. The upper arch surface data 22 in F2 may be registered to the upper reference surface data in FIG. 10 to produce the image shown in FIG. 12. In this way, the position of the upper arch is held constant for frames F1 and F2. The 3d data of the lower object system may then be registered to the image in FIG. 12 to produce the complete object system in position of frame No. 2, shown as FIG. 13.

This process may be repeated for each frame in a sequence producing a time-based set of 3d images that represent a 4d model. The basic rendering and animation of the 4d model shows the upper jaw, or skull, to be maintained in a fixed position and the incremental lower jaw position moved with respect to this fixed system. Interferences can be visualized, measured, and displayed, and dynamic surfaces may be developed by combining and smoothing the incremental positions of a selected surface of the object system.

In a preferred embodiment, contiguous upper and lower surface anatomy may be registered to the reference frame to expand its surface. This may be desired to ensure sufficient surface area for registering other frames in a 4d scan. Intermediate or connecting surface anatomy may also be used to enable the registration of object surfaces with a scan surface.

For the basic 4d method of FIG. 2, the upper and lower object system anatomy may be separately registered to each frame in the 4d sequence. Object system anatomy may be obtained from intraoral scanning or by scanning a cast of the teeth made from an impression. For posterior restorations of second or third molars with difficult visual access, it may be necessary to use overlapping connecting anatomy to relate the object system with the 4d scans.

### Example Using Six Degree of Freedom Expressions

This method is the basis for animating an antagonist object system by computing six degrees-of-freedom (6D of) mathematical expressions, as outlined in FIGS. 4 and 5. The following sequence is provided as a non-limiting example only. For this example, the full upper and lower arch of teeth is used as the object system. An equivalent result may be obtained using a different progression along the same technical aspects.

6D of expressions are coordinate transforms used to relate two coordinate systems to each other within the same space. Such transformations consist of a variety of functions that define both rotations and translations. The exact mathematical tools used to execute such transformations are apparent to those skilled in the art and are not described here. Reference frames may also be used for a 6D of method by defining the fixed location of the upper arch, and a starting position for the lower arch.

A 6D of expression is computed for each frame, and a set of 6 D of expressions corresponding to a sequence of frames forms the mathematical basis for the 4d motion simulation model. The 6D of expressions are used to mathematically describe the incremental change in position of the object system for each 4d frame. The 4d model produced by these methods is a mathematical representation of jaw movement. The model may serve as a forcing function for subsequent analyses as it defines the relative positions of the upper and lower arches. A mathematical representation of lower jaw motion is required in order to mathematically drive the 4d movement of antagonist teeth for CAD-designed restorations.

FIG. 8 shows a reference position with upper arch 14 and lower arch 16. FIG. 12 shows the upper data set of frame ‘n’ (for n=2) registered to the upper reference arch in FIG. 8, similar to that described above. The position of the jaw, or lower arch 24, in FIG. 12 is for frame 2. Since the upper data in FIGS. 8 and 12 (reference frame and frame 2) are in the same world coordinate system, the difference in position of the lower arch 24 data between frame 2 and the reference frame may be expressed by a 6D of expression. The 6D of expression for frame n is a mathematical expression that describes the movement of the lower arch 24 data from its reference position to its position in frame n. Continuing this process for each frame in a sequence produces a set of 6D of expressions that describes the 4d motion for a particular sequence. The 6D of expressions can then be used to drive the simulation of the object system.

Interpolation means can be used to compute 6D of expressions for intermediate positions between two 4d camera frames. This has the effect of smoothing the data between camera frames. Multidimensional spatial interpolation methods are known in the art.

In a preferred embodiment, the individual frame images from the 4d imaging unit are used to compute a set of 6D of expressions to define the coordinate system shifts associated with the change in position of the lower arch from its position in a reference frame to its position in frame n. The transform for frame n is a mathematical expression that, when applied to the lower arch data set of a reference frame, results in the position of the lower data set in frame n.

For the method of FIG. 5, the 4d scans are first used to determine a set of 6D of expressions. The antagonist or object system is then registered to a reference frame in the series, and the 6D of expressions are then used to animate the jaw motion.

Intra-oral scanning of an antagonist system can be expanded to include overlapping surface regions useful for registering to the 4d scans.

### Design Using Enhanced CAD

The ability to virtually animate the antagonist system to reflect patient-specific jaw motion, using either 6D of expressions or a registration-based 4d model, provides the information required to optimize the design of dental restorations. Restoration design can be enhanced by reducing interferences and optimizing crown anatomy which maximizes structure and provides more physiologic closing dynamics. The primary application of this invention is the enhanced design of implants, crowns, bridges, inlays, onlays, veneers, copings, and the like using clinical 4d data capture and utilization. The methods of this invention are particularly valuable when applied to multi-unit restorations.

The CAD of new teeth involves reducing or eliminating any interferences (unwanted tooth contact) and optimizing functional aspects. Optimizing the occlusal surface of a crown includes ensuring proper occlusion with antagonists such that contact takes place close to the opposing fossa on closure, while maximizing cusp height and width. The shape of a tooth designed in CAD is readily changed using software tools known in the art.

When antagonist teeth move in 3d, the surface of the clinical crowns sweeps-out a volume in space. The newly created external surface of this volume is called a dynamic surface because it represents the exterior surface of the locus of positions assumed by the moving tooth. A new tooth being designed should not interfere with or intersect this dynamic surface. Every moving tooth creates a dynamic surface as a result of its motion. A dynamic surface can be formed using two or more 3d images. If the newly designed tooth does not cut this surface, then it should have few or no interferences in the mouth.

The 4d model of the closing arc and chew cycles may assist with crown design by allowing cusp tips to be redesigned so they hit in the fossa of the antagonist tooth and not the wall or incline of the fossa. The cusp should cleanly enter and exit the fossa as the jaw is moved. By considering the true curved entry and egress paths of working cusps into and out of their fossa, CAD can be used to modify crown anatomy and cusp heights to ensure that new teeth do not contact the antagonist along an incline, as this non-physiologic situation can lead to tooth damage.

The 4d scanning of normal chewing action may also provide a dynamic chew-in surface with which a new tooth should not interfere. During the design process, the new tooth is adjusted to fit a person's actual chew cycle. As the chew cycle is visualized in 3d, holding cusp tips can be redesigned so they hit in the fossa of the opposing antagonist tooth and not the wall or incline of the fossa. The cusp should cleanly enter and exit the fossa as the jaw is moved.

The 4d scans may also be registered with 3d x-ray data. This may provide for the design of surgical guides for implant placement that consider patient-specific motion.

The basic 4d model may be visualized as moving 3d images. CAD software may have independent controls for motion speed, aspect, and zoom. In such a CAD system, relative motion may be reversed, stopped, or viewed in user-defined planes or aspects. The intersection of a new tooth with the dynamic surface can be visualized using a variety of means well-known in the art, including transparent surface and color-coded quantitative displays. The antagonist or new tooth surface may also be visualized as a transparent 3d solid, allowing the intersection of the new tooth and the antagonist to be readily visualized. A variety of visualization tools may be employed to illustrate and quantify the intersection of two 3d surfaces. Overlapping regions may be shown in color and the degree of intersection displayed using a color scale.

The entry and egress of cusps into and out of fossa may be visualized as well as how the teeth hit and slide into place. The point of first contact between teeth may be identified, its movement tracked in 3d, and the direction of a force vector may be computed. This may be valuable for designing load bearing structures such as copings and implants into bone. Motion and contact of the incisal edge to palatal surfaces of upper anterior teeth may also be visualized.

For CAD applications, it may also be useful to animate cross-sections to show dynamic interferences. Two-dimensional sections can be defined in CAD, and time-based visualizations may take place in that section. This can also be automated and used as a design tool.

Crown design may also be an iterative process between cusp optimization using the arc of closure and interference avoidance using a dynamic antagonist surface. This iterative process may be automated using software. The designer may first perform arc of closure-based design optimization against the antagonist surface and then check for interferences using a dynamic surface created from scan data. The static design can then be reconsidered.

Dental restorations should be stable in centric occlusion, enter and leave centric occlusion without exerting lateral forces, and not interfere with other teeth when the jaw is moved. The occlusal surface should allow cusps to enter and escape from their fossa without interference. Proper prosthetic fabrication should ensure that functional contact relationships are restored for both dynamic and static conditions. Teeth should contact in a harmonious manner with minimum force to supporting structures and an even load distribution across the arch. These criteria can only be satisfied using a 4d dynamic approach as provided by the methods of this invention.

### Commercial Implementation

The methods of this invention are amenable to practical working commercial operations which may allow the design of restorations to take place in the office or remotely. The details of integrating the 4d model into CAD software will vary with each commercial CAD package. Example commercial workflows are shown below (these examples are meant to be non-limiting and illustrative).

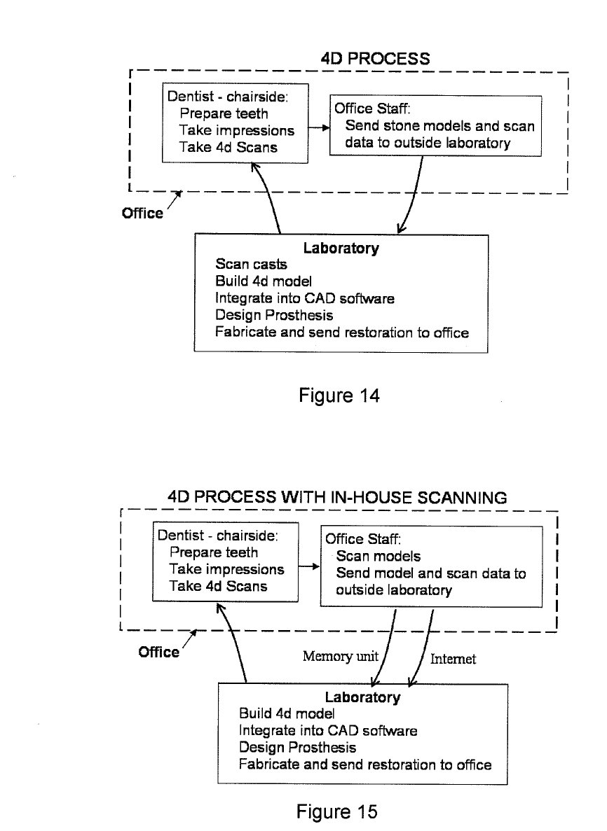

Basic 4d process (FIG. 14):
1. Dentist prepares tooth, takes upper and lower impressions, and takes 4d scans of a patient. Technicians pour stone models.
2. The 4d scan data is written to a digital recording medium and is sent to an outside laboratory with the stone casts.
3. The 4d scan data is integrated into the CAD software and used to assist with design.
4. The restoration is fabricated and sent back to the dentist.

Process with in-house model scanning (FIG. 15):
1. Dentist prepares tooth, takes upper and lower impressions, and takes 4d scans of a patient. Technicians pour stone models and scan the models using an in-house 3d scanner.
2. The 4d scan and 3d model data are written to a digital recording medium and is sent to an outside laboratory.
3. The 4d scan data is integrated into the CAD software and used to assist with design.
4. The restoration is fabricated and sent back to the dentist to be fitted to the patient.

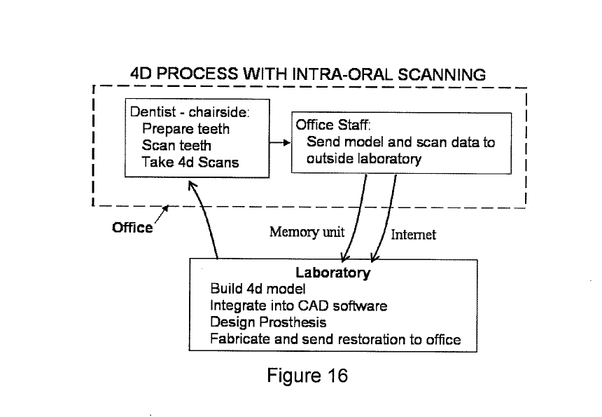

Process with intra-oral scanning (FIG. 16):
1. Dentist prepares tooth and scans the mouth of a patient capturing the antagonist system and any anatomy required to register the antagonist system with the 4d scan scans.
2. Dentist takes 4d scans of the patient.
3. The 4d scan and 3d model data are written to a digital recording medium and is sent to an outside laboratory.
4. The 4d scan data is integrated into the CAD software and used to assist with design.
5. The restoration is fabricated and sent back to the dentist to be fitted to the patient.

The invention may also be embodied as a dental device designed by a process utilizing a method according to the invention as depicted in FIG. 1.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method for designing a custom dental device, comprising the steps of:
obtaining a set of time-based 3-dimensional images of the oral anatomy of a person during jaw motion;
obtaining 3-dimensional data of a dental object of the person;
registering the 3-dimensional data of the dental object to at least one of the time-based 3-dimensional images;
using the time-based 3-dimensional images and registered 3-dimensional data to design a dental device.

2. The method of claim 1 wherein the dental object is a tooth, multiple teeth, a new tooth preparation, new tooth preparations, an antagonist tooth, an antagonist system, or soft tissue oral anatomy.

3. The method of claim 1 wherein the dental device is a dental restoration, an oral prostheses, or an oral appliance.

4. The method of claim 3 wherein the dental restoration is a crown or a bridge.

5. The method of claim 1 wherein the set of time-based 3-dimensional images comprises at least two three-dimensional images of the oral anatomy, wherein the at least two images are captured at different times during jaw motion.

6. The method of claim 1 wherein using the time-based 3-dimensional images and registered 3-dimensional data to design a dental device comprises obtaining a 4-dimensional data model of simulated motion of the dental object.

7. The method of claim 6 further comprising the step of using the 4-dimensional data model of simulated motion to generate a visual depiction of a motion of the dental object.

8. The method of claim 1, further comprising the step of using the set of time-based 3-dimensional images to generate a mathematical model describing a motion of the dental object, wherein the mathematical model comprises at least one six degrees-of-freedom expression.

9. The method of claim 8, further comprising the step of utilizing the mathematical model to design a dental restoration.

10. The method of claim 1 wherein the set of time-based 3-dimensional images is obtained by intra-oral scanning.

11. The method of claim 1 wherein the set of time-based 3-dimensional images is obtained by extra-oral scanning.

12. The method of claim 1 wherein using the time-based 3-dimensional images and registered 3-dimensional data to design a dental restoration comprises displaying on a computer display an indication of interference between the dental restoration and at least one antagonist tooth.

13. The method of claim 1 wherein using the time-based 3-dimensional images and registered 3-dimensional data to design a dental restoration comprises measuring the interference between the dental restoration and at least one antagonist tooth.

14. The method of claim 1 wherein using the time-based 3-dimensional images and registered 3-dimensional data to design a dental restoration comprises computing a dynamic surface or an arc-of-closure.

15. The method of claim 1 wherein using the time-based 3-dimensional images and registered 3-dimensional data to design a dental restoration comprises reducing interferences between the dental restoration and at least one antagonist tooth.

16. The method of claim 1 wherein using the time-based 3-dimensional images and registered 3-dimensional data to design a dental restoration comprises reshaping a virtual tooth to optimize the entry and/or egress of a working cusp into and/or out of an opposing fossa.

17. A dental device designed by a process comprising the steps of:
obtaining a set of time-based 3-dimensional images of the oral anatomy of a person during jaw motion;
obtaining 3-dimensional data of a dental object of the person;
registering the 3-dimensional data of the dental object to at least one of the time-based 3-dimensional images;
using the set of time-based 3-dimensional images and registered 3-dimensional data to design a dental device.
